(19) United States
(12) Patent Application Publication
(10) Pub. No.: US 2026/0126362 A1
(43) Pub. Date: May 7, 2026

(54) ACTUATOR-BASED TEST MACHINE CALIBRATION INSTRUMENT

(71) Applicant: Illinois Tool Works Inc., Glenview, IL (US)

(72) Inventors: Robert George Bowen, St. Peters, MO (US); Kevin Jay Rust, Waconia, MN (US)

(21) Appl. No.: 19/377,310

(22) Filed: Nov. 3, 2025

Related U.S. Application Data
(60) Provisional application No. 63/716,509, filed on Nov. 5, 2024.

(51) Int. Cl. G01N 3/62

(52) U.S. Cl. CPC G01N 3/62; G01N 2203/021

(57) ABSTRACT

A testing system calibration instrument includes a plurality of device inputs, a plurality of signal processing units, a display device, a controller and a housing that unifies the components. The plurality of signal processing units includes two or more of a millivolt/volt signal reader configured to produce a first calibration signal based on a millivolt/volt signal received from a first calibration sensor through one of the device inputs, a decoder configured to produce a second calibration signal based on an encoded signal received from a second calibration sensor through one of the device inputs, and a voltmeter configured to produce a third calibration signal based on an analog voltage signal received from a third calibration sensor through one of the device inputs. The controller is configured to control the display device to display information relating to the first calibration signal, the second calibration signal and/or the third calibration signal.

### CROSS-REFERENCE TO RELATED APPLICATIONS

The present application is based on and claims the benefit of U.S. provisional patent application Serial No. 63/716,509, filed November 5, 2024, the content of which is hereby incorporated by reference in its entirety.

### FIELD

Embodiments of the present disclosure generally relate to actuator-based test machines of dynamic testing systems and, more particularly, to a calibration instrument that facilitates calibration of test sensors of the test machines.

### BACKGROUND

Dynamic testing systems, such as those developed by MTS Systems Corporation, include test machines that perform various tests on a test specimen through the application of loads and/or displacements to the test specimen using one or more actuators. Test machines may be used to form a vehicle testing station that applies simulated driving conditions to a mobile vehicle or vehicle component, or a building testing station that applies simulated seismic activity to a building, for example.

Test machines utilize various test sensors during a test to measure aspects of a response from a specimen under test and/or to provide feedback for controlling the test. Such test sensors may include force transducers (e.g., load cell, torque transducer, pressure transducer, etc.) that may measure a force applied to the specimen, displacement sensors that may measure a displacement associated with an actuation of the specimen, an extensometer that may be used to measure a strain on the specimen, and other test sensors.

Such test sensors or sensing devices require periodic calibration to ensure their proper operation using various calibration sensors or devices. For example, a load cell of a test machine is typically calibrated using a calibration sensor in the form of a reference load cell that is placed in series with the load cell of the test machine. A displacement set by the test machine, such as a crosshead position, may be calibrated using a calibration sensor in the form of a displacement sensor (e.g., linear or angular displacement sensor) that measures the set displacement. An extensometer of a test machine may be calibrated using a calibration sensor in the form of an extensometer calibrator that opens the extensometer a known distance or applies a known strain to the extensometer.

Conventional calibration operations generally utilize a calibration computing device, that connects to one or more signal processing units (e.g., millivolt/volt signal reader, decoder, voltmeter, etc.) that are used to read the outputs from the calibration sensors, which may be presented on a display of the calibration computing device. The calibration computing device also connects to the test system computing device that is used to control the test machine and process the signals from its test sensors.

During a calibration computing device may control a test machine through communications with the test system computing device to stimulate its test sensors and corresponding calibration sensors, possibly along with a specimen. The sensed values from the test sensors and the calibration sensors may be displayed on the calibration computing device and used by the operator to calibrate aspects of the test machine.

A conventional setup of a calibration operation on a test machine generally utilizes an intermediary device that facilitates communications between the calibration computing device and a signal processing unit, and between the calibration computing device and the test station computing device through three RS232 serial communication ports. Thus, the calibration computing device receives the output from the processing unit and communicates with the test station computing device through the intermediary device.

This conventional setup of the calibration operation may involve numerous connections and cabling including a cable connection between the intermediary device and the calibration computing device, a cable connection between the intermediary device and the test system computing device, a cable between the intermediary device and the signal processing unit, and a cable between the signal processing unit and the calibration sensor, for example. When the operator would like to receive an output from a different calibration sensor, it may be necessary to connect the intermediary device to a different signal processing unit, which in turn must be connected to the calibration sensor. As a result, setting up the conventional calibration operation for an individual test machine can be a cumbersome, complicated and time-consuming task.

### SUMMARY

Embodiments of the present disclosure relate to a testing system calibration instrument that facilitates calibration of test sensors of actuator-based test machines and methods of operating the calibration instrument. One example of the calibration instrument includes a plurality of device inputs, a plurality of signal processing units, a display device, a controller and a housing that unifies the device inputs, the signal processing units, the display device and the controller. The plurality of signal processing units includes two or more of a millivolt/volt signal reader configured to produce a first calibration signal based on a millivolt/volt signal received from a first calibration sensor through one of the device inputs, a decoder configured to produce a second calibration signal based on an encoded signal received from a second calibration sensor through one of the device inputs, and a voltmeter configured to produce a third calibration signal based on an analog voltage signal received from a third calibration sensor through one of the device inputs. The controller is configured to control the display device to display information relating to the first calibration signal, the second calibration signal and/or the third calibration signal.

In some embodiments, the testing system calibration instrument includes a plurality of device inputs, a plurality of signal processing units, a plurality of communication ports, a display device, a controller and a housing that unifies the device inputs, the signal processing units, the communication ports, the display device and the controller. The plurality of signal processing units include a millivolt/volt signal reader configured to produce a first calibration signal based on a millivolt/volt signal received a first calibration sensor through one of the device inputs, a decoder configured to produce a second calibration signal based on an encoded signal received from a second calibration sensor through one of the device inputs, and a voltmeter configured to produce a third calibration signal based on an analog voltage signal received from a third calibration sensor through one of the device inputs. The controller is configured to control the display device to display information relating to the first calibration signal, the second calibration signal and/or the third calibration signal.

In one embodiment of a method of operating a testing system calibration instrument, the calibration instrument includes a plurality of device inputs, a plurality of signal processing units, a display device, a controller and a housing that unifies the device inputs, the signal processing units, the display device and the controller. The plurality of signal processing units includes two or more of a millivolt/volt signal reader configured to produce a first calibration signal based on a millivolt/volt signal received from a first calibration sensor through one of the device inputs, a decoder configured to produce a second calibration signal based on an encoded signal received from a second calibration sensor through one of the device inputs, and a voltmeter configured to produce a third calibration signal based on an analog voltage signal received from a third calibration sensor through one of the device inputs. The controller is configured to control the display device to display information relating to the first calibration signal, the second calibration signal and/or the third calibration signal. In the method, each of one or more calibration sensors is connected to one of the device inputs. One or more test signals are generated using one or more test sensors of an actuator-based test machine in response to stimulation of the one or more test sensors through the application of a force or a displacement to the one or more test sensors. One or more calibration sensor signals are generated using the one or more calibration sensors in response to, or in relation to, the stimulation of the one or more test sensors. The calibration sensor signals include: a millivolt/volt signal; an encoded signal; and/or an analog voltage signal. One or more calibration signals are produced by the signal processing units, each calibration sensor corresponds to one of the calibration sensor signals received through one of the device inputs including: producing a first calibration signal using the millivolt/volt signal reader based on the millivolt/volt signal; producing a second calibration signal using the decoder based on the encoded signal; and/or producing a third calibration signal using the voltmeter based on the analog voltage signal. The display device is controlled to display information relating to the first calibration signal, the second calibration signal and/or the third calibration signal using the controller.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram illustrating an example dynamic testing system and calibration system, in accordance with embodiments of the present disclosure.

FIG. 2 is a simplified diagram of an example of a calibration instrument, in accordance with embodiments of the present disclosure.

FIG. 3 is a flowchart illustrating an example method of operating a calibration instrument, in accordance with embodiments of the present disclosure.

FIG. 4 is a simplified diagram illustrating an example computing environment, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

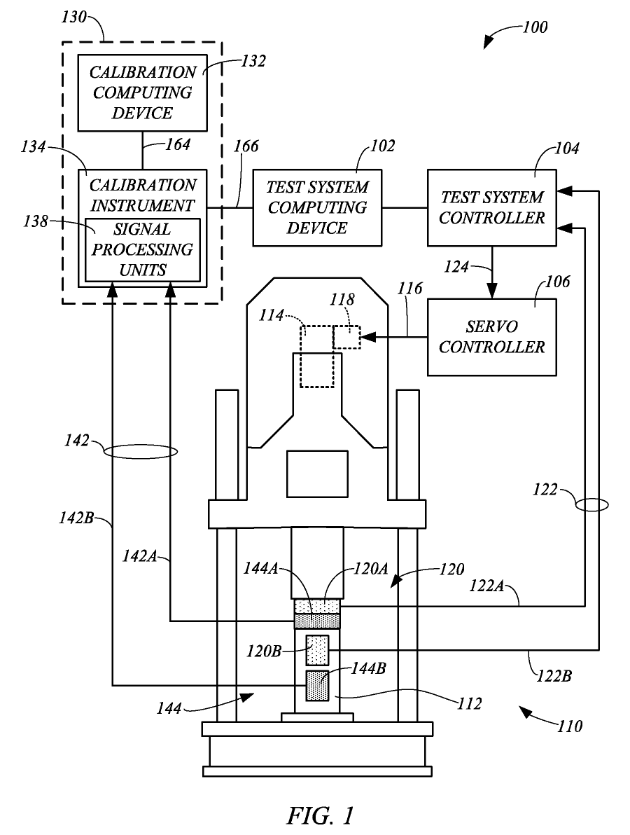

FIG. 1 illustrates an example of a conventional dynamic testing system 100, which includes a test system computing device 102, a test system controller 104 and a servo controller 106 that are used to control a test machine 110 for performing a test operation on a specimen 112 (e.g., material sample, substructure or components, etc.). The test system computing device 102 may be used to generate a graphical user interface on a display of the device 102 that allows a user to interact and/or control the test machine 110.

The test machine 110 includes at least one actuator 114 (e.g., hydraulic, pneumatic and/or electric) for imparting displacements and/or loads on a directly or indirectly coupled specimen 112. The servo controller 106 provides an actuator command signal 116 to a controlled device 118 (e.g. servo valve, power controller) to operate the actuator 114, which in turn excites the test specimen 112. It should be noted that the controller 104 is of a design suitable for controlling the type of actuator 114 being used.

A test operation that is defined using the test system computing device 102, may be performed through the control of the one or more actuators 114 by the test system controller 104. The types of loads that can be applied or imparted to the test specimen 112 by the one or more actuators 114 include, for example, tension, compression and/or torsion in one or more degrees of freedom applied separately or at the same time. The test specimen 112 can also or alternatively be subjected to controlled displacements in one or more degrees of freedom applied separately or at the same time.

One or more test sensors 120 provide feedback 122 to the test system controller 104 in the form of a measured or an actual response to an actuation of the specimen 112 during the test operation. The one or more test sensors 120 may include one or more transducers on the test specimen 112 or the test machine 110, such as a force transducer 120A (e.g., load cell, torque transducer, pressure transducer, etc.), and/or one or more other test sensors 120B, such as a displacement sensor, an extensometer, an accelerometer, a thermometer, or another test sensor, for example. The test sensors 120 provide measured or actual responses 122, such as signals 122A and 122B, as feedback to the servo controller 106, which uses the responses 122 to control the test machine 110 and perform a desired test operation.

During a test operation, the test system controller 104 may provide a reference signal 124 to the servo controller 106, which issues a corresponding actuator command signal 116 to the controlled device 118, which in turn drives movement of the actuator 114. The one or more test sensors 120 provide the feedback 122 to the test system controller 104, which adjusts the command signal 124 according to the defined test. It is understood that the dynamic testing system 100 shown in FIG. 1 is a simplified system (single channel case), and that embodiments of the present disclosure apply to systems 100 comprising multiple channels, such as multiple test sensors 120 or feedback components, and multiple actuators 114, for example.

FIG. 1 also illustrates a calibration system 130, in accordance with embodiments of the present disclosure. The calibration system 130 facilitates calibration of the test machines 110 of the system 100 and includes a calibration computing device 132 and a calibration instrument 134.

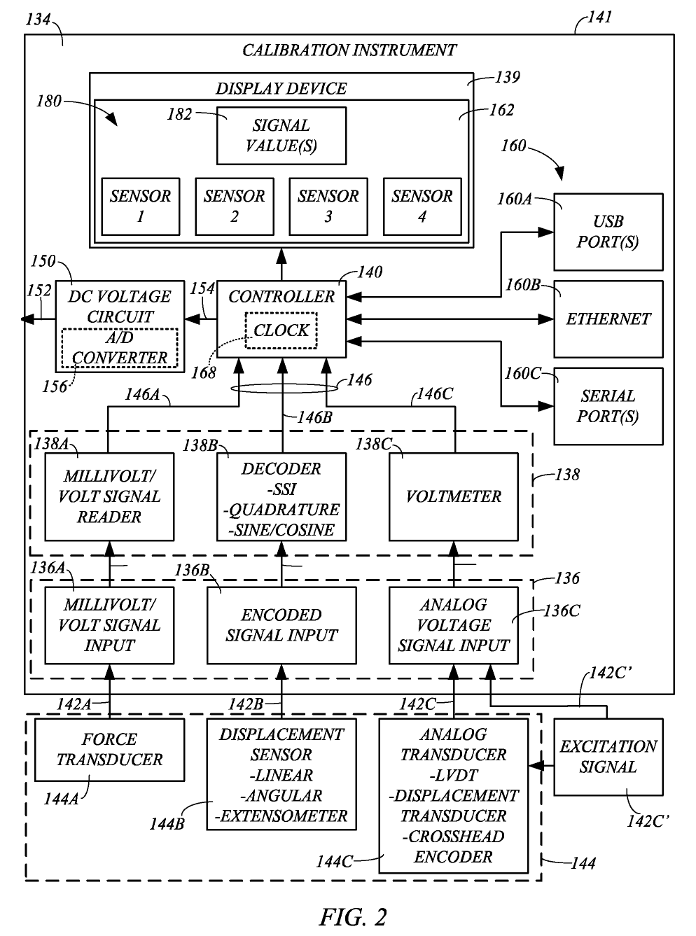

FIG. 2 is a simplified diagram of an example of the calibration instrument 134, in accordance with embodiments of the present disclosure. The calibration instrument 134 includes a plurality of device inputs 136, a plurality of signal processing units 138, a display device 139, a calibration controller 140 and a housing 141. The housing 141 unifies the components of the calibration instrument 134, such as the device inputs 136, the signal processing units 138, the display device 139 and the controller 140, such as by supporting and/or enclosing the components, for example.

The signal processing units 138 are configured to process one or more input signals 142 from calibration sensors 144 that are used during calibration of one or more of the test sensors 120 of one or more test machines 110, and produce corresponding calibration signals 146 (e.g., digital signals) that may be processed by the controller 140. The calibration sensors 144 may be selected based on the type of calibration being performed, in accordance with conventional techniques.

In some embodiments, the signal processing units 138 include a millivolt/volt signal reader 138A having a corresponding millivolt/volt input 136A, a decoder 138B having a corresponding encoded signal input 136B, and/or a voltmeter 138C having a corresponding analog voltage input 136C.

The millivolt/volt signal reader 136A generally operates to process millivolt/volt signals 142A from a force transducer 144A (e.g., a load cell (FIG. 1), a torque sensor, or a pressure sensor), and produces a corresponding force transducer signal 146A, such as a digital voltage representing a value corresponding to the signal 122A. The controller 140 is configured to process the force transducer signal 146A and control the display device 139 to display information relating to the force transducer signal 146A, such as a corresponding force value. Accordingly, the combination of the controller 140 and the millivolt/volt signal reader 138A may generally perform functions that are similar to those performed by the Model 9840 load cell indicator produced by Interface, for example.

In some embodiments, the one or more decoders 138B are generally configured to handle decoding of encoded signals 142B from displacement sensors 144B using conventional techniques to produce corresponding displacement signals 146B that are representative of the sensed displacement values. The displacement signals 146B may be processed by the controller 140, which may control the display device 139 to display the corresponding displacement values. The displacement sensors 144B may take on any suitable form, such as a linear or angular displacement transducer or encoder (e.g., the RPM0480UD70151B1102 position sensor produced by Temposonics,), a linear variable differential transformer (LVDT), an extensometer, and the like.

The one or more decoders 138B are configured to process the anticipated encoded displacement signals 142B, such as quadrature signals and the like to produce the corresponding displacement signal or signals 146B, which may be processed by the controller to extract linear and/or angular displacement values. Accordingly, the one or more decoders 138B may include a quadrature signal decoder for decoding quadrature type encoded signals 142B, a synchronous serial interface for receiving and decoding corresponding encoded signals 142B, and/or a sine/cosine signal decoder for decoding sine/cosine type encoded signals 142B, for example, as indicated in FIG. 2. Accordingly, the decoder 138B may operate in a similar manner as conventional stand-alone indicators, such as the ROD250 indicator produced by Heidenhain and the MICROCODE II indicator produced by Boeckeler, for example.

In some embodiments, the voltmeter 138C is configured to receive one or more analog voltage signals 142B (e.g., 0-12V) from conventional test machine analog transducers 144C through the input 136C. Examples of the analog transducers include an LVDT, a force transducer, a load cell, a torque sensor, a pressure sensor, a crosshead encoder that measures a position or displacement of a crosshead of the test machine 110, and an extensometer. The voltmeter 138C is configured to transform the received analog signals 142C into corresponding digital voltage signals 146C (e.g., 0-5V), which may be processed by the controller 140 and displayed on the display device 139, for example.

In some embodiments, the calibration instrument 134 is configured to receive multiple analog voltage signals 142C, such as an analog transducer signal 142C from the transducer 144C and an excitation signal 142C’ that is used to excite the analog transducer 144C, in accordance with conventional techniques. The excitation signal 142C’ may be generated by the test machine 110 or by another source. The analog voltage signal input 136C may include multiple ports for separately receiving the analog signals 142C and 142C’, and a multiplexor (not shown) may be used by the controller 140 to selectively pass the signals to the voltmeter 138C for processing. The controller 140 uses the digital voltage signals 142C and 142C’ to determine a value represented by the transducer signal 142C, which may be displayed on the display device 139.

In some embodiments, the calibration instrument 134 includes a direct current (DC) voltage circuit 150 that is configured to output a direct current voltage signal 152 (e.g., 0-12 VDC) based on a command signal 154 (e.g., a voltage signal) from the controller 140. The signal 152 may be used to control or excite an analog transducer, such as those mentioned above. In some embodiments, the signal is used to excite the analog transducer 144C.

The DC voltage circuit 150 may take on any suitable conventional form. In one example, the DC voltage circuit includes a digital-to-analog converter 156 that converts the digital voltage signal 154 (e.g., 0-5 VDC) into an analog voltage signal that may be processed by the circuit 150 (e.g., amplified) to output the corresponding direct current voltage signal 152.

In some embodiments, the calibration instrument 134 includes a plurality of data communication ports 160. Examples of the ports 160 include one or more universal serial ports 160A, Ethernet ports 160B and serial ports 160C (e.g., RS232 ports). The device inputs 136 may be formed using one or more of these communication ports 160, or by other conventional ports used to receive the corresponding signals 142.

The display device 139 may take on any suitable form and may be supported by or within a wall of the housing 141. In some embodiments, the display device 139 includes a touchscreen interface 162 that is configured to receive a user input that is communicated to the controller 140 for processing.

In some embodiments, a communication link 164 may connect the calibration instrument 134 to the calibration computing device 132 and a communication link 166 may connect the calibration instrument 134 to the test computing device 102, as shown in FIG. 1. The communication links 164 and 166 may take on any suitable form, such as a physical communication link (e.g., Universal Serial Bus (USB) cable, Ethernet cable, RS232 cable, etc.) or a wireless communication link (e.g., Bluetooth®, Wi-Fi, etc.).

The calibration instrument 134 facilitates control of the one or more testing machines 110 of the system 100 through the communication links 164 and 166 using an application interface executed on the calibration computing device 132 that works with the application interface executed on the test system computing device 102. Thus, the calibration computing device 134 may control the actuators 114 of the one or more test machines 110 of the system 100 to stimulate the test specimen 112 through the application of a force or displacement.

Alternatively, the calibration computing device 132 may replace the test system computing device 102 and utilize its own interface for controlling the one or more test machines 110, or the test system computing device 102 may be operated to control the actuators 114 of one or more test machines 110 to stimulate the test specimen 112, for example. Thus, for these options, at least the communication link 166 to the test system computing device 102 may be eliminated.

In some embodiments, the calibration instrument 134 includes a clock 168 having a clock signal that may be used by the controller 140 to calculate a velocity based on displacement values indicated by calibration signals 146B corresponding to calibration sensor signals 142B produced by a displacement sensor 144B over time using conventional techniques. The controller 140 may display the calculated velocities on the display device 139.

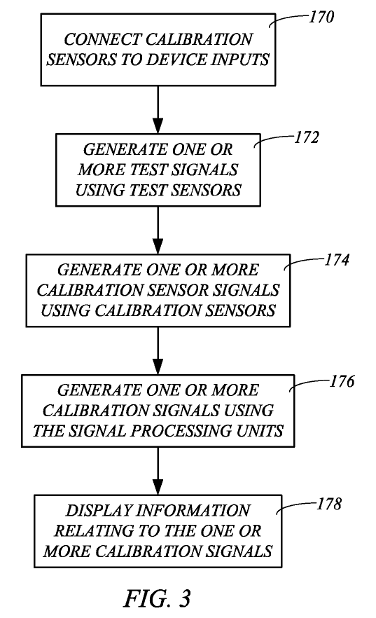

Calibrations of one or more actuator-based test machines 110 of a testing system 100 may be performed, at least partially, using the calibration instrument 134 formed in accordance with one or more embodiments described herein. FIG. 3 is a flowchart illustrating an example method of operating the calibration instrument 134, such as during the performance of a calibration operation, in accordance with embodiments of the present disclosure.

At 170, one or more calibration sensors 144 are each connected to one of the plurality of device inputs 136. For example, a calibration sensor 144A that is configured to output a millivolt/volt signal 142A, such as a force transducer (e.g., load cell, torque transducer, pressure transducer, etc.) may be connected to the millivolt/volt signal input 136A. Other types of calibration sensors 144 may be connected to the corresponding device input 136 based on their output signal type.

The one or more calibration sensors 144 may be arranged to perform a calibration of a corresponding test sensor 120 of the test machine 110. This generally involves setting up each of the calibration sensors 144 to measure parameters that relate to the calibration of the corresponding test sensors 120, as discussed above and in accordance with conventional techniques. For example, a calibration sensor in the form of a load cell 144A may be placed in series with the test load cell 120A of the test machine 110 during calibration of the test load cell 120A (FIG. 1), an extensometer calibrator may be used to apply a displacement or a strain to an extensometer test sensor 120 of the test machine 110 for calibration of the sensor, etc.

At 172, the one or more test sensors 120 being calibrated are stimulated to generate one or more corresponding test signals 122. The stimulation that is applied at 172 may involve the use of the actuators 114 of the test machine 110 to apply a displacement or force, which may be controlled using the calibration computing device 132 and/or the test system computing device 102 as discussed above. The stimulation of the test sensors 120 may also be driven using a device that is external to the test machine 110 (e.g., a turnbuckle, hand load frame) or by the corresponding calibration sensor 144 (e.g., extensometer calibrator), in accordance with conventional calibration techniques.

At 174 of the method, each of the one or more calibration sensors 144 are stimulated in response to, or in relation to, the stimulation of the one or more test sensors 120 to generate corresponding calibration sensor signals 142. For example, the stimulation of a test load cell 120A using the actuator 114 also stimulates the corresponding load cell calibration sensor 144A. As used herein, the setting of an extensometer calibrator 144B to apply a reference displacement or strain to an extensometer test sensor 120 constitutes a stimulation (step 174) of the extensometer calibrator 144B that is in relation to the stimulation of the extensometer test sensor 120.

At 176 of the method, one or more calibration signals 146 are produced using the one or more signal processing units 138 based on corresponding calibration sensor signals 142 received through one of the device inputs, as discussed above. Thus, the millivolt/volt signal reader 138A may produce a first calibration signal 146A based on a millivolt/volt signal 142A received at the millivolt/volt signal input 136A, the decoder 138B may produce a second calibration signal 146B based on the encoded signal 142B received at the encoded signal input 136B, and/or the voltmeter 138C may produce a third calibration signal 146C based on the analog voltage signal 142C received at the analog voltage signal input 136C.

At 178, the controller 140 controls the display device to display information 180 relating to one or more of the first calibration signal 146A, the second calibration signal 146, the third calibration signal 148C, and/or another calibration signal 146. The information 180 presented on the display device 139 may include one or more signal values 182 corresponding to received calibration signals 142, such as force values, displacement values, velocity values, etc.

In some embodiments, an interface is presented on the display device 139, through which a user may select a particular one of the calibration signals 142 to be displayed. In one example, a user may use the touchscreen interface 162 of the display device 139 to select one of the calibration sensors 144 (e.g., sensor 1-4) as an input to the controller 140, which then controls the display device 139 to display the information 180, such as the signal value 182 corresponding to the selected calibration sensor 144.

In some embodiments, step 176 involves simultaneously producing two or more of the calibration signals 146 based on corresponding calibration sensor signals 142. Thus, an operator may perform calibrations of multiple test sensors 120 at the same time, including test sensors 120 of different test machines 110.

The test system computing device 102, the test system controller 104, the calibration computing device 132 and the calibration controller 134 may take on any suitable form and can each be implemented on a digital and/or analog computer. Those skilled in the art will appreciate that embodiments of the present disclosure may be practiced with various computer system configurations, including multi-processor systems, networked personal computers, main frame computers, and the like. Aspects of the present disclosure may also be practiced in distributed computing environments where tasks are performed by remote processing devices that are linked through a communications network. In a distributed computer environment, program modules may be located in both local and remote memory storage devices.

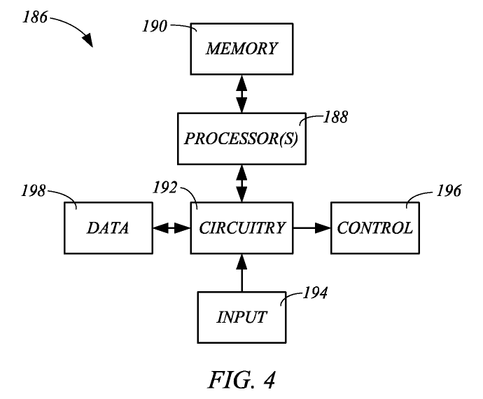

FIG. 4 is a simplified diagram illustrating an example computing environment or device 186 in which the test system computing device 102, the test system controller 104, the calibration computing device 132 and the calibration controller 134 may be implemented, in accordance with embodiments of the present disclosure. The example computing environment or device 186 may include one or more processors 188 and memory 190, which may be local memory or memory that is accessible to the controller 188. The one or more processors 190 are configured to perform various functions described herein in response to the execution of instructions contained in the memory 190, for example.

The one or more processors 188 may be components of one or more computer-based systems, and may include one or more control circuits, microprocessor-based engine control systems, and/or one or more programmable hardware components, such as a field programmable gate array (FPGA). The memory 190 represents local and/or remote memory or computer-readable media. As used herein, such memory 190 comprises any suitable patent subject matter eligible computer-readable media and does not include transitory waves or signals. Examples of the memory 190 include conventional data storage devices, such as hard disks, CD-ROMs, optical storage devices, magnetic storage devices and/or other suitable data storage devices.

The computing environment or device 186 may include circuitry 192 for use by the one or more processors 188 to receive input signals 194 (e.g., calibration sensor signals 142, input through the display device 139, etc.), issue control signals 196 (e.g., command signal 154, display control signals, etc.) and/or communicate data 198, such as in response to the execution of the instructions stored in the memory 190 by the one or more processors 188. For example, the calibration controller 140 may receive input signals 194 in the form of calibration sensor signals 146, a clock signal from the clock 168, user input through the touchscreen interface 162 of the display device 139, or input from a mouse/keyboard, etc., the control signals 196 may include control signals to the display device 139 or the command signal 154 to the DC voltage circuit 150, the data 198 may include data communicated to and/or from the calibration controller 140, such as through the ports 160 and to/from the calibration computing device 132 or the test system computing device 102.

Although the embodiments of the present disclosure have been described with reference to preferred embodiments, workers skilled in the art will recognize that changes may be made in form and detail without departing from the spirit and scope of the present disclosure.

What is claimed is:

1. A testing system calibration instrument for use in calibrating actuator-based test machines comprising:
a plurality of device inputs;
a plurality of signal processing units selected from the group consisting of:
a millivolt/volt signal reader configured to produce a first calibration signal based on a millivolt/volt signal received from a first calibration sensor through one of the device inputs;
a decoder configured to produce a second calibration signal based on an encoded signal received from a second calibration sensor through one of the device inputs; and
a voltmeter configured to produce a third calibration signal based on an analog voltage signal received from a third calibration sensor through one of the device inputs;
a display device;
a controller configured to control the display device to display information relating to the first calibration signal, the second calibration signal and/or the third calibration signal; and
a housing unifying the device inputs, the display device, the signal processing units and the controller.

2. The testing system calibration instrument according to claim 1, wherein:
the plurality of device inputs includes a millivolt/volt signal input;
the plurality of signal processing units includes the millivolt/volt signal reader that produces the first calibration signal based on a millivolt/volt signal received from the first calibration sensor through the millivolt/volt signal input; and
the information includes a value corresponding to the first calibration signal.

3. The testing system calibration instrument according to claim 2, wherein the first calibration sensor is selected from the group consisting of a force transducer, a load cell, a pressure transducer and a torque transducer.

4. The testing system calibration instrument according to claim 1, wherein:
the plurality of device inputs includes an encoded signal input;
the plurality of signal processing units includes the decoder that produces the second calibration signal based on an encoded signal received from the second calibration sensor through the encoded signal input; and
the information includes a value corresponding to the encoded calibration signal.

5. The testing system calibration instrument according to claim 4, wherein:
the second calibration sensor comprises a linear displacement sensor or an angular displacement sensor; and
the encoded signal comprises a linear displacement signal from the linear displacement sensor or an angular displacement signal from the angular displacement sensor.

6. The testing system calibration instrument according to claim 5, wherein:
the encoded signal comprises a quadrature signal; and
the decoder comprises a quadrature signal decoder.

7. The testing system calibration instrument according to claim 5, wherein the decoder comprises a synchronous serial interface.

8. The testing system calibration instrument according to claim 5, wherein:
the encoded signal comprises a sine/cosine signal; and
the decoder comprises a sine/cosine signal decoder.

9. The testing system calibration instrument according to claim 5, wherein:
the instrument comprises a clock configured to output a clock signal; and
the controller is configured to:
calculate a velocity based on the second calibration signal and the clock signal; and
the information includes a value corresponding to the calculated velocity.

10. The testing system calibration instrument according to claim 1, wherein:
the plurality of device inputs includes an analog voltage signal input;
the plurality of signal processing units includes the voltmeter that produces the third calibration signal based on an analog voltage signal received from the third calibration sensor through the analog voltage signal input; and
the information includes a value corresponding to the analog voltage signal.

11. The testing system calibration instrument according to claim 10, wherein the analog voltage signal corresponds to a sensed force, torque or pressure.

12. The testing system calibration instrument according to claim 10, wherein:
The third calibration sensor comprises a linear variable differential transformer (LVDT) or a crosshead encoder; and
the analog voltage signal comprises an LVDT signal from the LVDT corresponding to a displacement, or a crosshead encoder signal from the crosshead encoder corresponding to a displacement.

13. The testing system calibration instrument according to claim 10, wherein the analog voltage signal comprises a calibration sensor excitation signal sent to the calibration sensor.

14. The testing system calibration instrument according to claim 1, wherein:
the instrument includes a direct current voltage circuit configured to output a direct current voltage based on a command signal from the controller; and
the direct current voltage circuit is supported by the housing.

15. The testing system calibration instrument according to claim 1, including a plurality of universal serial bus (USB) ports connected to the controller and supported by the housing.

16. The testing system calibration instrument according to claim 1, including a plurality of serial ports connected to the controller and supported by the housing.

17. The testing system calibration instrument according to claim 1 including an ethernet port connected to the controller and supported by the housing.

18. The testing system calibration instrument according to claim 1, wherein:
the display device includes a touchscreen interface configured to receive a user input; and
the controller is configured to control the display device based on the user input.

19. A testing system calibration instrument for calibrating actuator-based test machines comprising:
a plurality of device inputs;
a plurality of signal processing units comprising:
a millivolt/volt signal reader configured to produce a first calibration signal based on a millivolt/volt signal received from a first calibration sensor through one of the device inputs;
a decoder configured to produce a second calibration signal based on an encoded signal received from a second calibration sensor through one of the device inputs; and
a voltmeter configured to produce a third calibration signal based on an analog voltage signal received from a third calibration sensor through one of the device inputs;
a plurality of communication ports;
a display device;
a controller configured to control the display device to display information relating to the first calibration signal, the second calibration signal and/or the third calibration signal; and
a housing unifying the device inputs, the display device, the signal processing units, the communication ports and the controller.

20. A method of operating a testing system calibration instrument, which comprises:
a plurality of device inputs;
a plurality of signal processing units selected from the group consisting of:
a millivolt/volt signal reader configured to produce a first calibration signal based on a millivolt/volt signal received through one of the device inputs;
a decoder configured to produce a second calibration signal based on an encoded signal received through one of the device inputs; and
a voltmeter configured to produce a third calibration signal based on an analog voltage signal received through one of the device inputs;
a display device;
a controller configured to control the display device to display information relating to the first calibration signal, the second calibration signal and/or the third calibration signal; and
a housing unifying the device inputs, the display device, the signal processing units and the controller;
the method comprising:
connecting each of one or more calibration sensors to one of the device inputs;
generating one or more test signals using one or more test sensors of an actuator-based test machine in response to stimulation of the one or more test sensors through the application of a force or a displacement to the one or more test sensors;
generating one or more calibration sensor signals using the one or more calibration sensors in response to or in relation to the stimulation of the one or more test sensors, the calibration sensor signals selected from the group consisting of:
a millivolt/volt signal;
an encoded signal; and
an analog voltage signal;
producing one or more calibration signals each corresponding to one of the calibration sensor signals received through one of the device inputs comprising:
producing a first calibration signal using the millivolt/volt signal reader based on the millivolt/volt signal;
producing a second calibration signal using the decoder based on the encoded signal; and/or
producing a third calibration signal using the voltmeter based on the analog voltage signal; and
controlling the display device to display information relating to the first calibration signal, the second calibration signal and/or the third calibration signal using the controller.

21. The method according to claim 20, wherein:
producing one or more calibration signals comprises simultaneously producing two or more of the first calibration signal, the second calibration signal and the third calibration signal; and
controlling the display device comprises controlling the display device to display information relating to the produced calibration signals.
